(19) United States
(12) Patent Application Publication
(10) Pub. No.: US 2024/0255611 A1
(43) Pub. Date: Aug. 1, 2024

(54) INFORMATION PROCESSING DEVICE AND INFORMATION PROCESSING METHOD

(71) Applicant: SONY SEMICONDUCTOR SOLUTIONS CORPORATION, KANAGAWA (JP)

(72) Inventor: RYOSUKE YAMADA, KANAGAWA (JP)

(21) Appl. No.: 18/560,743

(22) PCT Filed: Feb. 8, 2022
(86) PCT No.: PCT/JP2022/004811

§ 371 Date: Nov. 14, 2023

(30) Foreign Application Priority Data
May 28, 2021 (JP) 2021-089861

(51) Int. Cl. G01S 7/35; G01S 13/42

(52) U.S. Cl. CPC G01S 7/356; G01S 13/426

(57) ABSTRACT

The present technique relates to an information processing device and an information processing method that can reduce the load and time required for arithmetic processing in a radar device that uses a high-resolution algorithm. Fourier transform processing is executed on a received signal received by an antenna, a second spectrum is generated by cutting out a processing range from a first spectrum obtained by executing the Fourier transform processing, a steering matrix corresponding to the processing range is generated, and a high-resolution algorithm is applied based on the second spectrum and the steering matrix.

### TECHNICAL FIELD

The present technique relates to an information processing device and an information processing method, and particularly relates to an information processing device and an information processing method that can reduce the load and time required for arithmetic processing in a radar device that uses a high-resolution algorithm.

### BACKGROUND ART

PTL 1 discloses a radar device that detects (recognizes) a target object (a target) at high resolution using a high-resolution algorithm (a super-resolution algorithm).

### CITATION LIST

### Patent Literature

### [PTL 1]

JP 5114217B

### SUMMARY

### Technical Problem

When a high-resolution algorithm is used in a radar device to detect a target object at high resolution, it is desirable to reduce the load and time required for arithmetic processing.

Having been achieved in view of such circumstances, the present technique makes it possible to reduce the load and time required for arithmetic processing in a radar device that uses a high-resolution algorithm.

### Solution to Problem

An information processing device according to the present technique is an information processing device including: a Fourier transform unit that executes Fourier transform processing on a received signal received by an antenna; a cutout unit that generates a second spectrum by cutting out a processing range from a first spectrum obtained by executing the Fourier transform processing; a steering matrix generation unit that generates a steering matrix corresponding to the processing range; and a processing unit that applies a high-resolution algorithm based on the second spectrum and the steering matrix.

An information processing method according to the present technique is an information processing method by an information processing device including a Fourier transform unit, a cutout unit, a steering matrix generation unit, and a processing unit. The information processing method includes: executing Fourier transform processing on a received signal received by an antenna, by the Fourier transform unit; generating a second spectrum by cutting out a processing range from a first spectrum obtained by executing the Fourier transform processing, by the cutout unit; generating a steering matrix corresponding to the processing range, by the steering matrix generation unit; and applying a high-resolution algorithm based on the second spectrum and the steering matrix, by the processing unit.

In the information processing device and the information processing method according to the present technique, Fourier transform processing is executed on a received signal received by an antenna, a second spectrum is generated by cutting out a processing range from a first spectrum obtained by executing the Fourier transform processing, a steering matrix corresponding to the processing range is generated, and a high-resolution algorithm is applied based on the second spectrum and the steering matrix.

### BRIEF DESCRIPTION OF DRAWINGS

FIG. 1 is a diagram illustrating an example of the configuration of a first embodiment of a radar device in which the present technique is applied.

FIG. 2 is a diagram illustrating a high-resolution scanning range.

FIG. 3 is a diagram illustrating an example of an angle spectrum obtained by an angle FFT.

FIG. 4 is a diagram illustrating an example of an angle spectrum obtained by processing of a high-resolution algorithm.

FIG. 5 is a diagram illustrating the flow of processing performed by a radar processing unit of the radar device.

FIG. 6 is a diagram illustrating a steering matrix used in the processing of the high-resolution algorithm.

FIG. 7 is a diagram illustrating an example of the flow of processing performed by a radar processing unit of a radar device to which the present technique is not applied.

FIG. 8 is a diagram illustrating a first form of processing for cutting out data in a high-resolution scanning range from an angle spectrum.

FIG. 9 is a diagram illustrating a second form of processing for cutting out data in a high-resolution scanning range from an angle spectrum.

FIG. 10 is a diagram illustrating an example of the configuration of a second embodiment of a radar device in which the present technique is applied.

FIG. 11 is a diagram illustrating the flow of processing performed by a radar processing unit of the second embodiment.

### DESCRIPTION OF EMBODIMENTS

Hereinafter, embodiments of the present technique will be described with reference to the drawings.

### First Embodiment of Radar Device

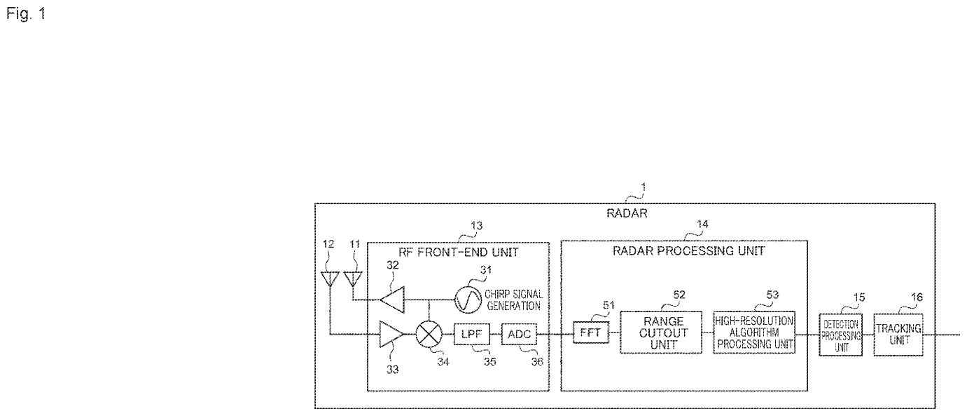

FIG. 1 is a diagram illustrating an example of the configuration of a first embodiment of a radar device in which the present technique is applied.

A radar device 1 illustrated in FIG. 1 is a device that detects a distance, a direction, and the like of an object (a target object) in space by emitting radio waves and capturing the resulting reflected waves. The radar device 1 is, for example, a Frequency Modulated Continuous Wave (FMCW) radar device that uses millimeter waves (30 GHz to 300 GHz in frequency) as the radio waves. However, the present technique may be applied even in radar devices aside from FMCW devices.

The radar device 1 includes a transmission antenna 11, a reception antenna 12, a radio frequency (RF) front-end unit 13, a radar processing unit 14, a detection processing unit 15, and a tracking unit 16.

The transmission antenna 11 radiates a transmission signal supplied by the RF front-end unit 13 as radio waves (transmission waves) into the air.

The reception antenna 12 receives radio waves that arrive after being emitted from the transmission antenna 11 and reflected by an object (a target object) (also called received waves, reflected waves, or arrival waves). The received waves received by the reception antenna 12 are supplied as a received signal to the RF front-end unit 13.

The reception antenna 12 is constituted by a plurality of reception antennas arranged, for example, in a linear form (an array antenna), and in FIG. 1, the plurality of reception antennas are illustrated as the single reception antenna 12. When referring to the plurality of reception antennas explicitly, the reception antennas will be referred as reception antennas 12-1 to 12-N (where N is the number of reception antennas). The reception antenna 12 is not limited to a linear array antenna, and may also be an array antenna in which the antennas are arranged in a planar (two-dimensional) manner.

The RF front-end unit 13 generates the transmission signal and supplies the signal to the transmission antenna 11, and provides an Intermediate Frequency (IF) signal to the radar processing unit 14 in response to the received signal from the reception antenna 12.

The radar processing unit 14 calculates a distance spectrum, an angle spectrum, a velocity spectrum, and the like based on the IF signal from the RF front-end unit 13. The distance spectrum is information that specifies the distance from the radar device 1 to the position where the object is present (the distance of the object) in a scanning range (a measurement range) of the radar device 1, which is the entire spatial range over which the radar device 1 can detect objects. The angle spectrum is information that specifies the direction of the position where an object is present (the direction of the object) in the scanning range of the radar device 1. Taking, for example, the position of the radar device 1 (the reception antenna 12) as a reference position and a predetermined direction as seen from the reference position as a reference direction (a central direction of the scanning range of the radar device 1, for example), the direction of an object is expressed as an angle between the reference direction and the position where the object is present from the reference position. The direction of the object is also called the angle of the object. In the following, both “direction” and “angle” represent a direction or angle with respect to a predetermined reference direction as seen from a predetermined reference position. The velocity spectrum is information that specifies the movement velocity of a moving object. Information such as the distance spectrum, the angle spectrum, and the like obtained by the radar processing unit 14 is supplied to the detection processing unit 15.

The detection processing unit 15 detects an object of interest (a target object; a target) based on the information from the radar processing unit 14, and specifies the distance, direction (angle), and the like of the target object relative to the radar device 1. Note that the target object may be a moving object, an object of a predetermined type, or the like. Target object information about the detected object, such as a spatial region in the space occupied by the detected target object, the distance and direction of the target object, and the like is supplied to the tracking unit 16.

The tracking unit 16 tracks the target object detected by the detection processing unit 15 based on the target object information from the detection processing unit 15. Tracking information (a movement trajectory and the like) of the tracked target object and the target object information from the detection processing unit 15 are supplied to a processing unit (not shown) that performs processing such as imaging.

The detection processing unit 15 and the tracking unit 16 may be any processing units according to the application of the radar device 1, and will therefore not be described in detail.

### (Configuration of and Processing by RF Front-End Unit 13)

The RF front-end unit 13 includes a chirp signal generation unit 31, amplifier units 32 and 33, a mixing unit 34, a low-pass filter (LPF) unit 35, and an A/D conversion unit 36.

The chirp signal generation unit 31 generates a frequency modulated chirp signal from a sine wave signal and supplies the chirp signal to the amplifier unit 32 and the mixing unit 34. The chirp signal is, for example, a signal whose frequency is continuously (linearly) changed (swept) from a predetermined minimum frequency to a predetermined maximum frequency in a predetermined period.

The amplifier unit 32 amplifies the chirp signal from the chirp signal generation unit 31 and supplies the amplified signal to the transmission antenna 11.

The amplifier unit 33 amplifies the received signal from the reception antenna 12 and supplies the amplified signal to the mixing unit 34.

The mixing unit 34 generates an IF signal by mixing the chirp signal from the chirp signal generation unit 31 and the received signal from the amplifier unit 33. The IF signal is a beat signal having a difference frequency (beat frequency), which is the difference between the frequency of the received signal and the frequency of the chirp signal. The IF signal generated by the mixing unit 34 is supplied to the LPF unit 35.

The LPF unit 35 removes high frequency components such as noise from the IF signal from the mixing unit 34 and supplies the resulting signal to the A/D conversion unit 36.

The A/D conversion unit 36 samples the value of the IF signal from the LPF unit 35 at a predetermined sampling cycle and converts the sampled value from an analog value to a digital value. The IF signal is converted from an analog signal to a digital signal as a result. The IF signal converted to a digital signal is supplied to the radar processing unit 14.

Note that the IF signals for N channels corresponding to respective ones of the plurality of reception antennas 12-1 to 12-N in the reception antenna 12 are supplied to the radar processing unit 14 from the RF front-end unit 13. The RF front-end unit 13 includes the amplifier unit 33, the mixing unit 34, the LPF unit 35 and the A/D conversion unit 36 for the N channels corresponding to respective ones of the reception antennas 12-1 to 12-N. However, the RF front-end unit 13 may not include the processing units 33 to 36 for the N channels, by having one or more of these processing units 33 to 36 perform processing for a plurality of channels through time division processing.

### (Configuration of and Processing by Radar Processing Unit 14)

The radar processing unit 14 is a processing unit constituted by a Digital Signal Processor (DSP), and by executing programs, constructs a Fast Fourier Transform (FFT) unit 51, a range cutout unit 52, and a high-resolution algorithm processing unit 53.

The FFT unit 51 performs distance FFT, velocity FFT, and angle FFT (azimuth FFT) processing on the IF signal from the A/D conversion unit 36 of the RF front-end unit 13. Expressed in complex notation, the IF signal is expressed as Sig in the following Formula (1).

$$\begin{matrix}[ Math . 1 ] & \\ Sig = exp [ j ( 2 π ( f + S τ ) t ) \} = exp \{ j ( 2 π \frac{2 V}{c} {St}^{2} + 2 π \frac{2 ( R + V \frac{f}{S} ) + rx \cdot d sin ( θ )}{c} St + 2 π \frac{2 V ( f + S t )}{c} n \cdot Tc + 2 π \frac{rx \cdot d \cdot sin ( θ}{c} f + 2 π \frac{2 R f}{c} ) \} & ( 1 )\end{matrix}$$

Note that τ in the first right-hand side of Formula (1) represents a delay time. τ is expressed by the following Formula (2), and thus the second right-hand side of Formula (1) is derived.

$$τ = \{ 2 ( R + V \cdot n \cdot Tc ) + rx \cdot d \cdot sin ( θ ) \} / c \qquad ( 2 )$$

Here, c represents the speed of light (m/sec); f represents a carrier frequency (Hz); t represents the elapsed time when the start of each chirp in the chirp signal is set to 0 (the time elapsed from when the frequency started to increase); n represents the chirp number (from 1 to a maximum chirp number); rx represents the number of the reception antennas 12-1 to 12-N (1 to N); R represents the distance between the target object (the target) and the radar device 1 (m); V represents the relative velocity between the target object (target) and the radar device 1 (m/sec); θ represents the angle between the target object (target) and the radar device 1 (the angle between the central direction of the scanning range of the radar device 1 and the direction of the target object); Tc represents a chirp interval (period) (sec); S represents the slope of the chirp (a rate of increase in the sweep frequency) (Hz/sec); and the interval (m) of the reception antennas 12-1 to 12-N.

The distance FFT is a Fast Fourier Transform (FFT) that frequency-transforms the IF signal from the A/D conversion unit 36 from a time-domain representation (a representation by a function with time t as a variable) to a frequency-domain representation (a representation by a function with frequency as a variable). The distance FFT is performed on the IF signal of each channel corresponding to the respective ones of the reception antennas 12-1 to 12-N. This produces a spectrum (a spectrum signal) that shows a high intensity at a frequency corresponding to the distance of an object (a target object) in the full scanning range of the radar device 1. Because frequency has a certain relationship to the distance of an object, the spectrum for the frequency (frequency spectrum) obtained by the distance FFT can be regarded as the spectrum for the distance of the object corresponding to the frequency (the distance of the position from the radar device 1 where the object can be present, called simply “distance” hereinafter). In the following, “distance spectrum” is assumed to refer to the spectrum for the distance.

The velocity FFT is an FFT that performs a frequency transformation from a time-domain representation to a frequency-domain representation on component signals, which are data for the same distance arranged in time series in the distance spectrum data obtained by the distance FFT. For example, IF signals for M cycles (chirp frames) supplied from the A/D conversion unit 36 to the FFT unit 51 in correspondence with chirp signals for a predetermined number of cycles (M cycles) output from the chirp signal generation unit 31 of the RF front-end unit 13 are taken as a single set of IF signals. The distance FFT is performed for each IF signal in a single chirp frame, and thus when the distance FFT is performed for one set of IF signals, the distance spectrum data for M chirp frames is obtained as one set of distance spectrum data. In the velocity FFT, a frequency transformation through an FFT is performed on component signals, which are M pieces of data for the same distance arranged in time series in the single sets of distance spectrum data (temporal component signals of the distance spectrum). This produces a spectrum that shows a high intensity at a frequency corresponding to the movement velocity of the object (the relative velocity between the radar device 1 and the object). The velocity FFT is repeated each time one set of IF signals is supplied from the A/D conversion unit 36 to the FFT unit 51. The velocity FFT may be performed only on the temporal component signals of the distance spectrum for distances where an object is determined to be present from the distance spectrum, or may be performed on the temporal component signals of the distance spectrum for the full range of distances in the distance spectrum. Note that because there is a constant relationship between the frequency in the frequency domain when the frequency is transformed by the velocity FFT and the movement velocity of an object, the spectrum for the frequency obtained through the velocity FFT (the frequency spectrum) can be regarded as the spectrum for the movement velocity of the object corresponding to the frequency (the velocity at which the object can move, referred to simply referred to as the “velocity” hereinafter). In the following, “velocity spectrum” is assumed to refer to the spectrum for the velocity. The velocity is not limited to cases of being detected through the velocity FFT, and there may also be cases where no velocity FFT is performed.

The angle FFT is an FFT using data of the distance/velocity spectra for each channel obtained by the distance/velocity FFTs for the IF signal of each channel corresponding to respective ones of the plurality of reception antennas 12-1 to 12-N. Note that the data of the distance spectrum and the velocity spectrum obtained through the distance FFT and the velocity FFT (the distance/velocity FFTs) will be referred to as “distance/velocity spectra data”. Specifically, in the angle FFT, a frequency transformation from a spatial-domain representation to a frequency-domain representation is performed through the FFT on component signals arranged spatially taking N pieces of data (data for N channels) for the same distance and the same velocity in the distance/velocity spectra data for each channel as values at the positions of the reception antennas 12-1 to 12-N respectively corresponding thereto (spatial component signals of the distance/velocity spectra). This produces a spectrum that shows a high intensity at the frequency corresponding to the angle at which the object is present (the angle between the central direction of the scanning range of the radar device 1 and the direction of the object). The angle FFT may be performed only on the spatial component signals of the distance/velocity spectra for distances and velocities at which an object is determined to be present from the distance/velocity spectra, or may be performed on the spatial component signals of the distance/velocity spectra for the full range of distances and velocities in the distance/velocity spectra. Note that because there is a constant relationship between the frequency in the frequency domain when the frequency is transformed by the angle FFT and the angle of an object, the spectrum for the frequency in the frequency domain when the frequency is transformed through by the angle FFT (the frequency spectrum) can be regarded as the spectrum for the angle of the object corresponding to the frequency (the angle (direction) of the position at which the object can be present relative to the radar device 1 (the reception antenna 12), referred to simply as an “angle” hereinafter). In the following, “angle spectrum” is assumed to refer to the spectrum for the angle.

The FFT unit 51 provides the distance spectrum obtained by the distance FFT, the velocity spectrum obtained by the velocity FFT, the angle spectrum obtained by the angle FFT, and the like to the range cutout unit 52, the high-resolution algorithm processing unit 53, and the detection processing unit 15 as necessary, as information on the distance, movement velocity, and angle of the object present in the scanning range of the radar device 1.

The range cutout unit 52 determines (sets) a high-resolution scanning range based on the information from the FFT unit 51. The high-resolution scanning range represents the range, out of the overall scanning range of the radar device 1, in which scanning pertaining to angles (directions) is performed at a high resolution using a high-resolution algorithm. In other words, the high-resolution scanning range represents a range of angles in which the angle of arrival (arrival direction) of the arrival waves arriving at the radar device 1 (the reception antenna 12) is estimated at a high resolution using the high-resolution algorithm.

For example, the range cutout unit 52 takes an angle of the peak (maximum) intensity greater than or equal to a predetermined threshold in the angle spectrum obtained through the angle FFT, and determines a range of angles where a difference from that angle is lower than or equal to the predetermined threshold (a range of some angles including the angle of the peak out of the overall scanning range) as the high-resolution scanning range.

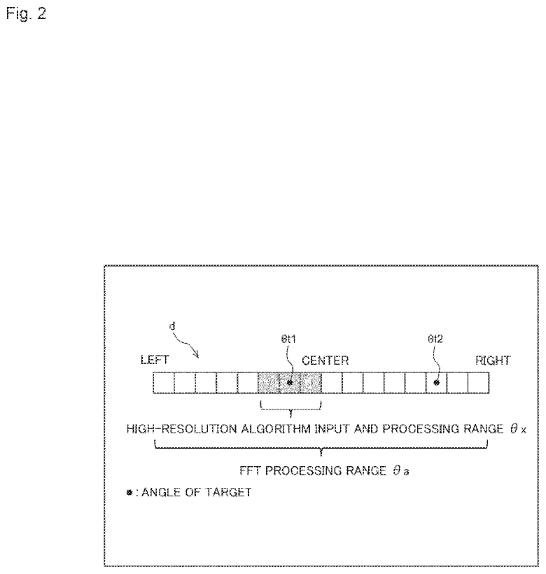

FIG. 2 is a diagram illustrating the high-resolution scanning range. In FIG. 2, a data sequence d represents the data of the angle spectrum obtained through the angle FFT, and the center of the data sequence d represents the position in the data sequence relative to an angle 0 of the angle spectrum obtained through the angle FFT (the angle representing the central direction of the scanning range of the radar device 1). The data of the angle spectrum are the component values obtained through the angle FFT (complex amplitude components containing information on the magnitude and phase of the amplitude). FIG. 2 illustrates a case in which 16 pieces of data for an angle range θa are obtained through the angle FFT.

Assume that data showing a peak in the intensity of the angle spectrum (an intensity corresponding to the magnitude of the amplitude) is obtained at an angle θt1 and an angle θt2 in FIG. 2. Of the angle θt1 and the angle θt2, assume that the magnitude of the amplitude indicated by the data for angle θt1 is greater than or equal to a predetermined threshold. In this case, the range cutout unit 52 takes a range up to the angle of the data adjacent to the data of the angle θt1 in the data of the angle spectrum the high-resolution scanning range. In other words, when the angle spectrum data is calculated every angle 40, the range of angles where the angle difference is less than the threshold 40 with respect to the angle θt1 of the peak in the angle spectrum is determined to be the high-resolution scanning range. However, the high-resolution scanning range need not be the range of angles of data adjacent on both sides to the data at the angle θt1, where the intensity of the angle spectrum shows a peak, and may instead be a range up to at least two consecutive pieces of data adjacent on both sides to the data at the angle θt1. As an example, if the scanning range of the radar device 1 is an angle range of approximately 120 degrees, the high-resolution scanning range is set to a size of approximately 10 to 20 degrees, for example.

Assume that the intensity indicated by the data at the angle θt2 is also greater than or equal to the predetermined threshold, like the data at the angle θt1. In this case, the range cutout unit 52 determines a range of angles where the angle difference is less than or equal to the predetermined threshold with respect to angle θt2, in the same manner as with the angle θt1, as the high-resolution scanning range. The high-resolution scanning ranges for the angle θt1 and the angle θt2 are treated as independent high-resolution scanning ranges.

For each distance and velocity of the distance/velocity spectra obtained through the distance/velocity FFTs, the range cutout unit 52 determines the high-resolution scanning range for the angle spectrum obtained through the angle FFT. The range cutout unit 52 may determine the high-resolution scanning range only for the angle spectrum for a distance for which the difference from the distance indicating a peak in the intensity greater than or equal to the predetermined threshold in the distance/velocity spectra obtained through the distance/velocity FFTs is less than or equal to the predetermined threshold. In other words, the range cutout unit 52 may determine the range of angles in which an object is estimated to be present by limiting the range to the distances at which the object is estimated to be present. In this case, the FFT unit 51 may calculate the angle spectrum only for a distance for which the difference from the distance indicating a peak in the intensity greater than or equal to the predetermined threshold in the distance/velocity spectra obtained through the distance/velocity FFTs is less than or equal to the predetermined threshold.

The range cutout unit 52 supplies the information on the determined high-resolution scanning range and the data on the angle spectrum in that high-resolution scanning range to the high resolution algorithm processing unit 53. If a plurality of high-resolution scanning ranges are determined, the angle range information and the angle spectrum data for each high-resolution scanning range are supplied to the high-resolution algorithm processing unit 53.

Based on the information on the high-resolution scanning range from the range cutout unit 52 and the data of the angle spectrum in the high-resolution scanning range, the high-resolution algorithm processing unit 53 uses a high-resolution algorithm to detect (estimate), at a high resolution, the angle of an object present in the high-resolution scanning range, i.e., the angle of arrival of arrival waves in the high-resolution scanning range.

Here, the angle spectrum supplied from the FFT unit 51 to the range cutout unit 52 is the result of estimating the arrival direction of the arrival waves (received waves) received by the reception antenna 12 using a Fourier transform-based beamformer method as the arrival direction estimation method. The beamformer method has a lower resolution than an arrival direction estimation method which uses a high-resolution algorithm, but the amount of calculations is smaller, and thus the load and time required for the arithmetic processing are smaller as well. Accordingly, the calculation of the angle spectrum by the FFT unit 51 is performed in a short time.

The high-resolution algorithm requires more calculations than the beamformer method, and thus the load and time required for the arithmetic processing are greater, but the resolution is higher. In the present embodiment, the high-resolution algorithm is any arrival direction estimation method that has a higher resolution than the beamformer method. Capon, Compressed Sensing (CS), Linear Prediction (LP), Pisarenko, MUltiple SIgnal Classification (MUSIC), Estimation of Signal Parameters via Rotational Invariance Techniques (ESPRIT), Deterministic Maximum Likelihood, Weighted Subspace Fitting, Root-MUSIC, and the like are well-known high-resolution algorithms. The high-resolution algorithm processing unit 53 may use any of these well-known high-resolution algorithms, which have higher resolutions than the beamformer method, for estimating the arrival direction.

In the present technique, for the scanning range of the radar device 1, the direction in which an object is present is estimated using the arrival direction estimation method that has low processing load and time even at low resolutions. As a result of the estimation, the angle at which the object is present, i.e., the angle of arrival (arrival direction) of the arrival waves is estimated at a high resolution using the high-resolution arrival direction estimation method only for the scanning range where the object is estimated to be present, excluding at least a scanning range where the object is estimated not to be present. This greatly reduces the load and time required for arithmetic processing compared to estimating the angle of arrival using a high-resolution arrival direction estimation method for the entire scanning range of the radar device 1. According to this, the present technique includes a case where, with respect to the FFT unit 51 which uses a low-resolution arrival direction estimation method and the high-resolution algorithm processing unit 53 which uses a high-resolution arrival direction estimation method, the former is a processing unit which estimates the arrival direction using an algorithm having a lower processing load (a lower amount of calculations) and a lower resolution than the latter, whereas the latter is a processing unit which estimates the arrival direction using an algorithm having a higher resolution than the former. Accordingly, the present technique includes a case where the FFT unit 51 is a processing unit that estimates the arrival direction using a method other than the beamformer method as the arrival direction estimation method.

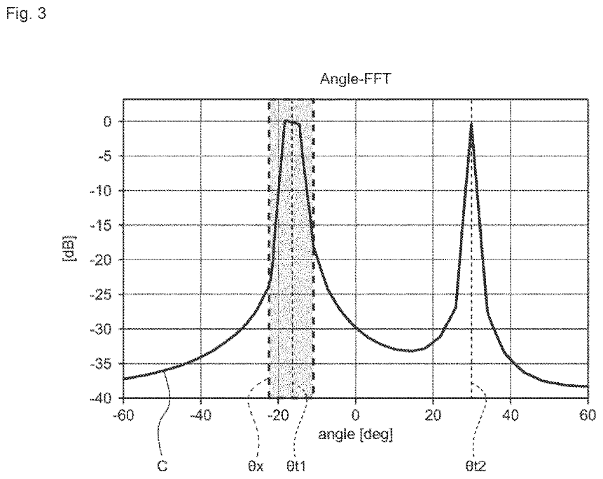

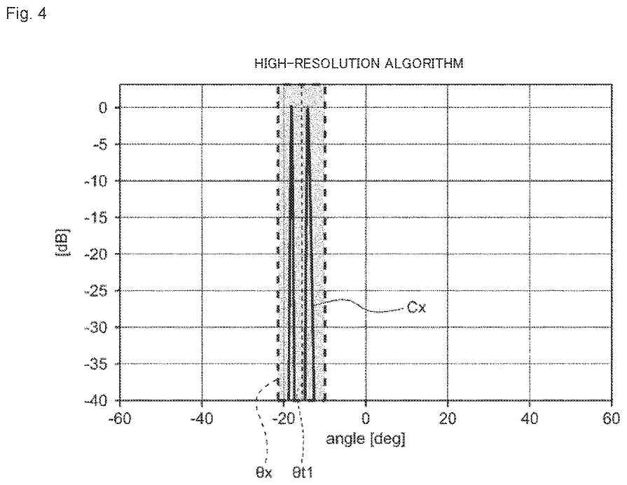

FIG. 3 illustrates the intensity of the angle spectrum obtained through the angle FFT performed by the FFT unit 51, and FIG. 4 illustrates the intensity of the angle spectrum obtained by the processing of the high-resolution algorithm performed by the high-resolution algorithm processing unit 53.

In FIG. 3, an angle spectrum C is a graph of the intensity of the data sequence d of the angle spectrum illustrated in FIG. 2. The angle θt1 and the angle θt2 represent the angles of intensity peaks in the angle spectrum C, in the same manner as in FIG. 2. An angle range Ox of the high-resolution scanning range, which is an angle range including the angle θt1 (called a “high-resolution scanning range θx” hereinafter), represents the high-resolution scanning range determined by the range cutout unit 52 for the angle θt1.

The high-resolution algorithm processing unit 53 performs the high-resolution algorithm processing on the high-resolution scanning range θx based on the information on the high-resolution scanning range θx from the range cutout unit 52 and the data of the angle spectrum C in the high-resolution scanning range θx. As a result, the angle spectrum in FIG. 4, for example, is calculated by the high-resolution algorithm processing unit 53.

In FIG. 4, an angle spectrum Cx represents the intensity of the angle spectrum obtained by the high-resolution algorithm processing unit 53. The angle θt1 and the high-resolution scanning range θx are the same as in FIG. 3.

According to this, the high-resolution scanning range θx is limited to a partial angle range among the scanning range of the radar device 1 (an angle range of approximately −60 to 60 degrees), and the high-resolution scanning range θx is limited to an angle range including the angle θt1 indicated in FIG. 3 (approximately −25 to −15 degrees). At this time, the angle spectrum of the high-resolution scanning range θx is calculated at a high resolution by the high-resolution algorithm processing unit 53 using a high-resolution algorithm.

In the angle spectrum C in FIG. 3, obtained through the angle FFT by the FFT unit 51, only the presence of one coherent object in the direction of the angle θt1 is detected. In contrast, in the high-resolution angle spectrum Cx in FIG. 4, obtained by the high-resolution algorithm processing unit 53, two peaks appear within the high-resolution scanning range θx. Accordingly, two separate objects at different angular directions within the high-resolution scanning range θx are detected as being present.

The high-resolution algorithm processing unit 53 calculates a high-resolution angle spectrum for each of the high-resolution scanning ranges supplied by the range cutout unit 52 and supplies the spectra to the detection processing unit 15 in a later stage.

The detection processing unit 15 detects the distance, movement velocity, angle, and the like of the objects present in the scanning range of the radar device 1 based on the distance spectrum, the velocity spectrum, and the angle spectrum (the low-resolution angle spectrum) obtained through the distance FFT, the velocity FFT, and the angle FFT, respectively, performed by the FFT unit 51, as well as the high-resolution angle spectrum obtained by the high-resolution algorithm processing unit 53, and determines an object (target object) of interest.

### <Flow of Processing by Radar Processing Unit 14 of Radar Device 1>

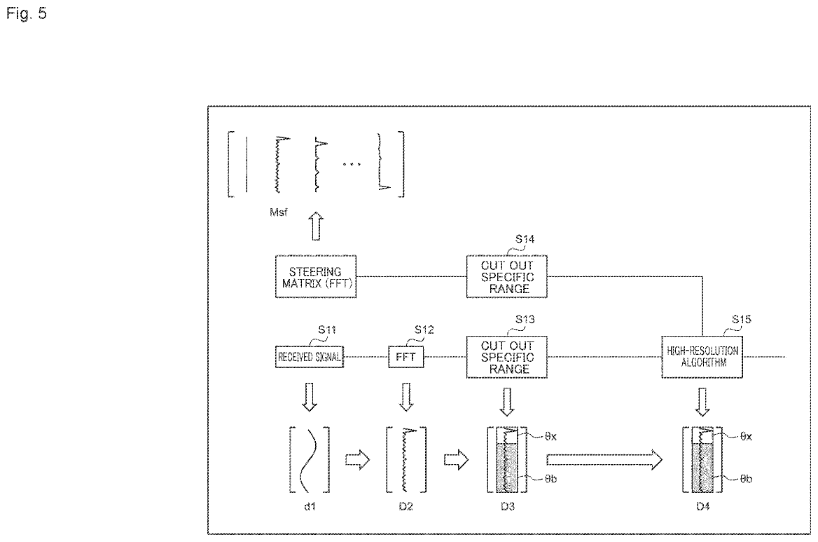

FIG. 5 is a diagram illustrating the flow of processing performed by the radar processing unit 14 of the radar device 1.

In step S11, the FFT unit 51 of the radar processing unit 14 obtains, through the reception antenna 12 (12-1 to 12-N) and the RF front-end unit 13, the received signals of the channels corresponding to the respective ones of the reception antennas 12-1 to 12-N. Each received signal represents the signal between each channel at a specific distance and velocity after the distance FFT and the velocity FFT are applied to the IF signal of each channel obtained from the RF front-end unit 13 in the radar processing unit 14. Here, assume that a radio wave reflected by a single object (object point) (received wave) arrives at a predetermined angle with respect to the reception antennas 12-1 to 12-N (the same applies hereinafter). At this time, due to the angle of arrival of the received wave (the angle of the object), a phase difference occurs between the IF signals of each channel (the phase of the IF signal is different in each channel). In other words, when the IF signal of each channel is represented by complex notation, a difference in a phase ψ of the complex amplitude component of each IF signal varies according to the angle of arrival of the received wave. The received signal includes the value of exp(jφ) of the complex amplitude component of each IF signal (hereafter, exp(jφ) will simply be called the “complex amplitude component”). The data sequence (steering vector) when exp(jφ), which is the complex amplitude component in the received signal, is arranged in the column direction (vertical direction) corresponding to the array of the reception antennas 12-1 to 12-N is represented by a simulated graph as a data sequence d1 in FIG. 5. Note that the graph of the data sequence d1 is represented by a straight line if, for example, the angle of arrival of the received wave (the angle of the object) is 0 degrees (the received wave arrives from the central direction of the scanning range of the radar device 1).

In step S12, the FFT unit 51 performs the angle FFT on the received signal obtained in step S11. An angle spectrum that shows a higher intensity at the angle of arrival of the received wave (the angle of the object) is obtained through the angle FFT. A data sequence of the angle spectrum values with respect to the angle every predetermined interval, obtained by the FFT unit 51, is represented by a simulated graph as a data sequence D2 in FIG. 5, when arranged in the column direction.

In step S13, the range cutout unit 52 cuts out the angle spectrum data of a specific angle range to be used as the high-resolution scanning range θx from the angle spectrum data obtained in step S12. For example, the range cutout unit 52 determines a range of angles at which the difference, from an angle at which the intensity of the angle spectrum shows a peak greater than or equal to a predetermined threshold, is lower than or equal to a predetermined threshold, among the angle spectrum data, as the high-resolution scanning range θx. The range cutout unit 52 cuts out the data of the high-resolution scanning range θx, among the angle spectrum data. A data sequence D3 in FIG. 5 indicates that the data in a partial high-resolution scanning range θx is cut out from the data sequence D2 of the angle spectrum obtained by the FFT unit 51, and the data in the other range θb is not used.

In step S14, the high-resolution algorithm processing unit 53 cuts out the range of a steering matrix corresponding to the high-resolution scanning range θx cut out in step S13.

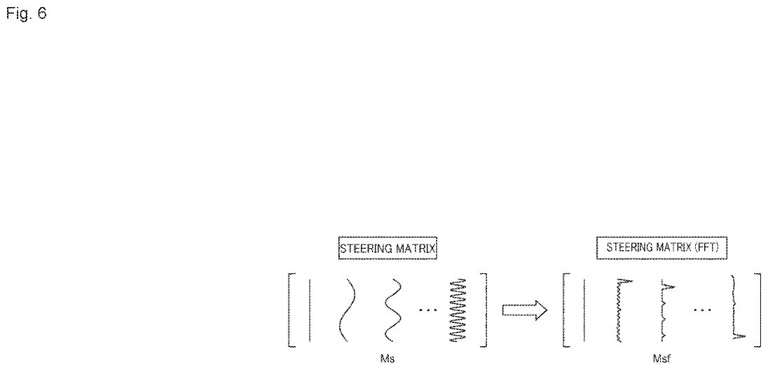

FIG. 6 is a diagram illustrating the steering matrix used in the processing by the high-resolution algorithm processing unit 53.

In FIG. 6, a steering matrix Ms indicates an original steering matrix used in high-resolution algorithms such as Capon and MUSIC. The data in each column of the steering matrix Ms (data sequence) is a data sequence obtained by arranging the data of the complex amplitude components of the received signals received by each of the reception antennas 12-1 to 12-N, from arrival waves arriving at a predetermined angle of arrival from the same wave source, in the column direction in correspondence with the arrangement of the reception antennas 12-1 to 12-N (a steering vector; a direction matrix). In other words, the component values in the column direction of the steering matrix Ms represent oscillations in amplitude caused by phase differences between the received signals received at each of the reception antennas 12-1 to 12-N according to the angle of arrival of the arrival wave (received wave). The steering matrix Ms represents a matrix of steering vectors at each angle of arrival of the received wave when the angle of arrival is changed at predetermined intervals (see the data sequence d1 in FIG. 5), shifted in the row direction.

A steering matrix Msf represents the steering matrix used by the high-resolution algorithm processing unit 53 to which the present technique is applied. The data sequence in each column of the steering matrix Msf corresponds to the steering vector in each column of the steering matrix Ms (the steering vector for each angle of arrival) being replaced by the data of component values for each frequency at predetermined intervals obtained by the frequency transforms performed using FFTs. Because the frequency in the frequency domain when the steering vector is frequency-transformed through the FFT has a constant relationship with the angle of arrival, the data sequences in the column direction of the steering matrix Msf are the component values corresponding to the angle of arrival. The steering matrix Msf, which is referred to by the high-resolution algorithm processing unit 53, is denoted as “steering matrix (FFT)” in FIGS. 5 and 6 to be distinguished from the steering matrix Ms. The steering matrix Msf will be referred to as a “steering matrix (FFT) Msf” hereinafter.

In step S14 of FIG. 5, the high-resolution algorithm processing unit 53 cuts out a range of component values corresponding to the high-resolution scanning range θx, cut out in step S13, from the steering matrix (FFT) Msf, which is prepared in advance. In other words, because the component values in the column direction (the vertical direction) of the steering matrix (FFT) Msf correspond to the angle of arrival (the angle of the object), the high-resolution algorithm processing unit 53 takes a range cut out in the column direction of the steering matrix (FFT) Msf as the range of the component values corresponding to the angle of arrival in the high-resolution scanning range θx. Each column of the steering matrix (FFT) Msf corresponds to a case where the arrival waves arrive at angles of arrival at predetermined intervals. The high-resolution algorithm processing unit 53 sets a range to be cut out in the row direction of the steering matrix (FFT) Msf to a range of columns corresponding to the angles of arrival within the high-resolution scanning range θx. As the interval of the angles of arrival corresponding to each column of the steering matrix (FFT) Msf decreases, the resolution of the angle spectrum obtained by the high-resolution algorithm increases. However, the number of columns in the steering matrix (FFT) Msf also increases by a corresponding amount, which increases the load and time required for the arithmetic processing. In the following, a matrix constituted by the component values in a partial range cut out from the steering matrix (FFT) Msf will also be referred to as the steering matrix (FFT) Msf.

In step S15, the high-resolution algorithm processing unit 53 performs processing using the high-resolution algorithm based on the data of the angle spectrum in the high-resolution scanning range θx cut out in step S13 and the steering matrix (FFT) Msf cut out in step S14. A high-resolution angle spectrum in the high-resolution scanning range θx is calculated as a result. A data sequence D4 in FIG. 5 represents that for the data sequence D2 of the angle spectrum obtained in step S12, the data of the high-resolution angle spectrum in the high-resolution scanning range θx is calculated, but the data in the angle range θb outside the high-resolution scanning range θx is not calculated.

The high-resolution algorithm is a well-known high-resolution algorithm such as Capon or MUSIC. However, the high-resolution algorithm processing unit 53 uses the steering matrix (FFT) Msf cut out in step S14 instead of the steering matrix used in the well-known high-resolution algorithm (corresponding to the steering matrix Ms in FIG. 6). The high-resolution algorithm processing unit 53 uses the angle spectrum data of the high-resolution scanning range θx cut out in step S13 instead of the received signal data used in the well-known high-resolution algorithm. The high-resolution algorithm itself in the high-resolution algorithm processing unit 53 is well known, and will therefore not be described.

The reason why, in step S15, the high-resolution algorithm processing unit 53 can perform the processing of the high-resolution algorithm using the steering matrix (FFT) Msf and the angle spectrum data instead of using the steering matrix Ms and the received signal data will be described here. Assume that a column vector of the received signals y1, y2, . . . , yN in each channel, received by the reception antennas 12-1 to 12-N, respectively, arranged in the column direction, is taken as a received signal vector y. A column vector obtained when x1, x2, . . . , xL, which represent the radio waves arriving at the reception antenna 12 for each angle of arrival θl (l=1, 2, . . . , L), are arranged in the column direction, is taken as a power distribution x. In this case, the received signal vector y is expressed by the following Formula (3), using the steering matrix Ms in FIG. 6. Note that the symbol “⋅” denotes the product of matrices.

$$Y = Ms \cdot x \qquad ( 3 )$$

Note that strictly speaking, the received signal vector x is expressed by a formula in which a noise vector is added to the right side of Formula (3), but the noise vector is omitted here.

An algorithm that calculates the power distribution x, which is an unknown value, using the received signal vector y in Formula (3) as an observed value and the steering matrix Ms as a known value (to estimate the arrival direction of radio waves), is well-known as a high-resolution algorithm. For example, in the MUSIC method, an autocorrelation matrix is created using the observed received signal vector y, and the arrival direction of radio waves at the reception antenna 12 is estimated from the autocorrelation matrix and the steering matrix Ms.

In contrast, multiplying both sides of Formula (3) by a matrix F of the Fourier transform results in the following Formula (4).

$$F \cdot y = F \cdot Ms \cdot x \qquad ( 4 )$$

Here, F·y is the Fourier transform of the received signal vector y (corresponding to the angle spectrum), and F·Ms is the Fourier transform of each column of the steering matrix Ms (corresponding to the steering matrix (FFT) Msf). Assuming F·y=y′ and F·Ms=Msf, Formula (4) is expressed by the following Formula (5).

$${y}^{′} = Msf \cdot x \qquad ( 5 )$$

Because Formula (3) and Formula (5) have the same form, the algorithm for calculating the power distribution x (estimating the arrival direction of the radio waves) based on the general Formula (3) can be applied directly to Formula (5). Accordingly, the high-resolution algorithm processing unit 53 can perform the processing of the well-known high-resolution algorithm using the angle spectrum data, which is the data of the received signal vector y′ after the Fourier transform of Formula (5), and the steering matrix (FFT) Msf, and can calculate the power distribution x (to estimate the arrival direction of the radio waves).

### Advantages of Present Technique

According to the radar device 1 described above, a range in which an object is present and a range in which no object is present can be identified quickly through the processing of an FFT (estimating the arrival direction using the low-resolution beamformer method), which involves a low arithmetic processing load. Through this, at least only a range where an object is present is scanned through the processing of the high-resolution algorithm, which involves a large arithmetic processing load, and the range where the object is present and the range where no object is present are identified at an even higher resolution. Accordingly, objects are recognized at a high resolution in important ranges, and an increase in the load and time required for arithmetic processing is suppressed. According to the radar device 1, the data obtained through the FFT can be used as-is to perform the processing of the high-resolution algorithm, which reduces the amount of calculations as well as the load and time required for arithmetic processing. According to the radar device 1, the range to which the high-resolution algorithm is applied is limited to a part of the scanning range of the radar device 1, and thus the dimensions of data to be input to the high-resolution algorithm are reduced, and the amount of calculations is greatly reduced. In Capon, which is one of the high-resolution algorithms, the amount of calculations increases to the order of the third power with respect to the dimensions of the input data, and thus reducing the number of dimensions has a major effect on reducing the amount of calculations.

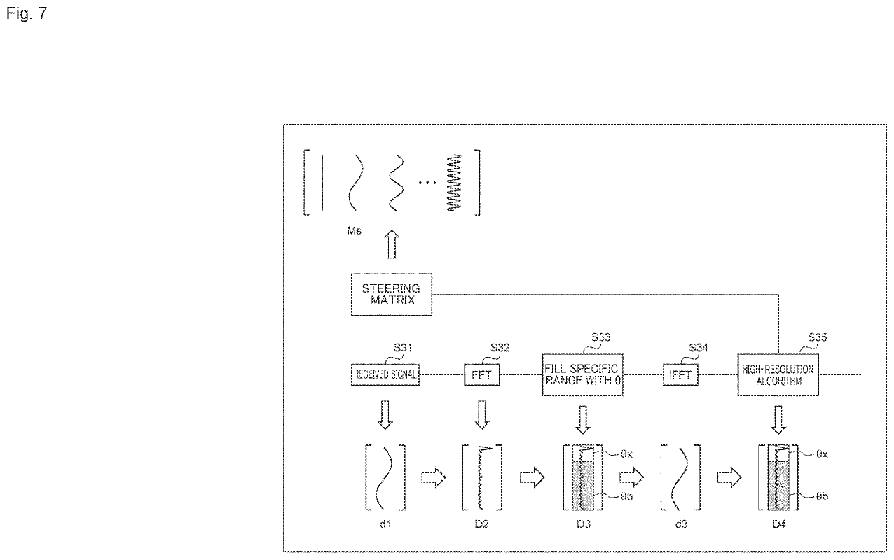

FIG. 7 is a diagram illustrating an example of the flow of processing performed by a radar processing unit of a radar device to which the present technique is not applied.

In FIG. 7, step S31 and step S32 are the same processing as step S11 and step S12 in FIG. 5, and will therefore not be described.

In step S33, a specific angle range is determined as the high-resolution scanning range θx from the entire angle spectrum obtained through the angle FFT in step S32, in the same manner as in step S13 in FIG. 5. However, in step S13 of FIG. 5, only data in the high-resolution scanning range is cut out (extracted) among the data for the entire angle range of the angle spectrum. Step S33 in FIG. 7 differs from step S13 in FIG. 5 in that data from the entire angle range of the angle spectrum, with the exception of the data in the high-resolution scanning range, are replaced with zero values.

In step S34, an Inverse Fast Fourier Transform (IFFT) is performed on the angle spectrum obtained in step S33, and an IF signal (received signal) is generated excluding the data of the angle spectrum outside the high-resolution scanning range θx. In other words, an IF signal is generated by removing the signal of the received wave at an arrival direction that is an angle outside the high-resolution scanning range.

In the radar processing unit 14 to which the present technique is applied, the processing corresponding to step S34 is unnecessary, and thus the load and time required for arithmetic processing are reduced.

In step S35, the processing of the high-resolution algorithm is performed based on the data of the IF signal obtained through the IFFT in step S34 and the steering matrix Ms. A high-resolution angle spectrum in the high-resolution scanning range θx is calculated as a result. In this step S35, the dimensions of the data input to the high-resolution algorithm are not reduced, and thus the amount of calculations is not reduced.

In the radar device 1 to which the present technique is applied, the processing of the high-resolution algorithm is performed without using the IF signal data of the number of channels corresponding to the number of reception antennas 12-1 to 12-N as in step S35, which reduces the load and time required for the arithmetic processing.

### <Form of Range Cutout Unit 52>

Forms of the processing of cutting out data as the high-resolution scanning range θx from the angle spectrum obtained through the angle FFT by the range cutout unit 52 illustrated in FIG. 1 and in step S13 in FIG. 5 will be described below.

### (First Form)

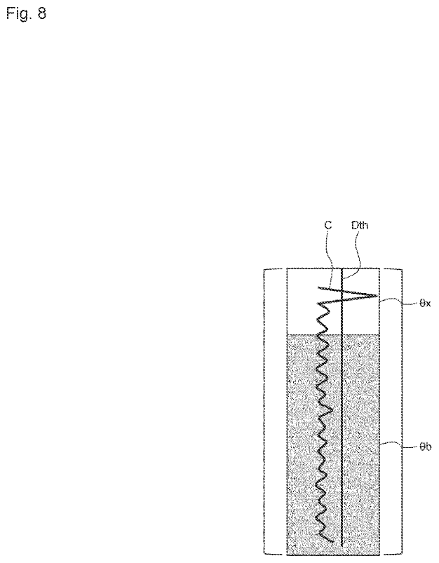

FIG. 8 is a diagram illustrating a first form of processing through which the range cutout unit 52 cuts out data in the high-resolution scanning range θx from the angle spectrum. In FIG. 8, the angle spectrum C represents the intensity of the angle spectrum obtained through the angle FFT performed by the FFT unit 51.

The range cutout unit 52 takes, as the high-resolution scanning range θx, a range, among the entire angle range of the angle spectrum obtained through the angle FFT, of angles at which an angle difference, from an angle when a peak in the intensity of the angle spectrum is greater than or equal to a predetermined threshold Dth, is less than or equal to a predetermined threshold. Note that the first form is the embodiment described above.

### (Second Form)

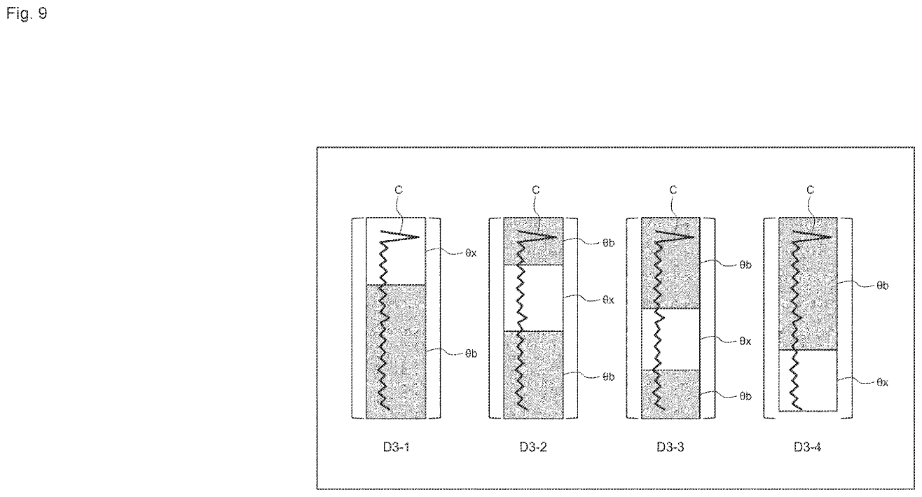

FIG. 9 is a diagram illustrating a second form of processing through which the range cutout unit 52 cuts out data in the high-resolution scanning range from the angle spectrum.

In FIG. 9, data sequences D3-1 to D3-4 represent identical data sequences of angle spectra obtained through the angle FFT performed by the FFT unit 51.

In each of the data sequences D3-1 to D3-4, the angle spectrum C is a graph indicating the data in each of the data sequences D3-1 to D3-4, and is an example of the intensity of the angle spectrum obtained through the angle FFT performed by the FFT unit 51. The high-resolution scanning range θx represents the angle range over which the range cutout unit 52 cuts out the data, and the angle range θb represents the angle range over which data is not cut out (unused data).

The range cutout unit 52 switches the high-resolution scanning range θx for the data sequence of the angle spectrum obtained through the angle FFT performed by the FFT unit 51 in the order of the data sequences D3-1 to D3-4, for example, regardless of the value of the angle spectrum C. In this case, part of the angle range of the high-resolution scanning range is set to overlap with part of the angle range of the previous high-resolution scanning range. The high-resolution scanning range may be determined in advance such that the angle ranges at both ends overlap with part of the angle range of another high-resolution scanning range, with the exclusion of those set at both ends of the angle range of the angle spectrum. The high-resolution scanning ranges set at both ends of the angle range of the angle spectrum may be determined in advance such that part of the angle range on the opposite side of the angle spectrum from the end of the angle range overlaps part of the angle range of another high-resolution scanning range. The range cutout unit 52 cuts out the angle spectrum data for the angles included in the high-resolution scanning range θx set in sequence and supplies the data to the high-resolution algorithm processing unit 53 in a later stage, and causes the high-resolution angle spectrum in the high-resolution scanning range θx to be calculated. This makes it possible to calculate high-resolution spectra in sequence for the entire angle range of the angle spectrum obtained through the angle FFT performed by the FFT unit 51.

According to the second form, the amount of calculations is reduced compared to a case where a high-resolution angle spectrum is calculated by performing the processing of a 1-degree high-resolution algorithm for the entire angle range of the angle spectrum obtained through the angle FFT performed by the FFT unit 51, which reduces the load and time required for arithmetic processing.

### Other Embodiments

As another form of the processing through which the range cutout unit 52 cuts out the data of the high-resolution scanning range from the angle spectrum, the range cutout unit 52 may set the angle range in which a target object to be taken as a target is present, or an angle range of high importance, as the high-resolution scanning range.

For example, an image of the scanning range of the radar device 1 taken by a camera (an image capturing unit) is obtained by a processing unit in the radar device 1, such as the radar processing unit 14. The processing unit of the radar device 1 detects the direction (angle range) in which the target object is present from that image. Based on the information detected by the processing unit, the range cutout unit 52 sets the angle range where the target object is present as the high-resolution scanning range for the angle spectrum obtained through the angle FFT performed by the FFT unit 51.

For example, when the radar device 1 is installed on a moving body such as an automobile that can change its direction of movement, the range cutout unit 52 obtains information on the position or direction of movement of the moving body from a position sensor or inertial sensor installed on the moving body, or a sensor or the like in an operating unit that changes the direction of movement of the moving body. The range cutout unit 52 detects whether the direction of movement of the moving body has been changed to another direction of movement, such as the right or left direction relative to the previous direction of movement, based on the information obtained from the sensor. The direction of movement of the moving body changing means that the movement trajectory of the moving body is a trajectory aside from a straight line. The direction of movement of the moving body being changed can therefore be a case where the direction of movement of the moving body relative to the central direction of the scanning range of the radar device 1 is changed, or a case where the moving body of the moving body is changed along with the central direction of the scanning range of the radar device 1. Upon detecting that the direction of movement of the moving body has been changed, the range cutout unit 52 may set a partial angle range corresponding to the changed direction of movement of the moving body as the high resolution scanning range for the entire angle range of the angle spectrum obtained through the angle FFT performed by the FFT unit 51. For example, if the direction of movement of the moving body is changed from the central direction of the scanning range of the radar device 1 to the right direction, a partial angle range on the right side of the entire angle range of the angle spectrum (the scanning range of the radar device 1) is set as the high-resolution scanning range. If no change in the direction of movement of the moving body is detected, the range cutout unit 52 may skip setting the high-resolution scanning range, or may set a partial angle range at the center of the entire angle range of the angle spectrum, or the entire angle range, as the high-resolution scanning range.

### Second Embodiment of Radar Device

A second embodiment of the radar device to which the present technique is applied is an embodiment for a case where, as the high-resolution algorithm, an algorithm is used which cannot calculate a high-resolution angle spectrum using a partial range of component values among the component values of a common steering matrix (FFT) when the high-resolution scanning range is different.

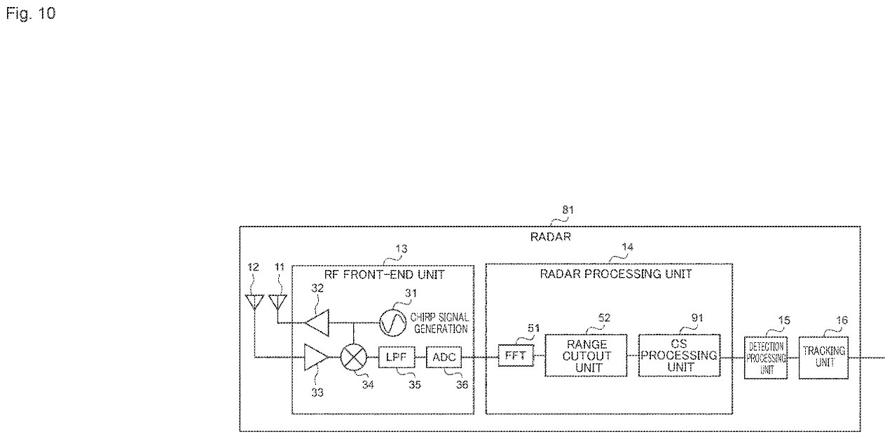

FIG. 10 is a diagram illustrating an example of the configuration of the second embodiment of the radar device in which the present technique is applied. Note that parts that are the same as in the radar device 1 of the first embodiment illustrated in FIG. 1 are given the same signs, and will not be described as appropriate.

A radar device 81 in FIG. 10 includes the transmission antenna 11, the reception antenna 12, the RF front-end unit 13, the radar processing unit 14, the detection processing unit 15, and the tracking unit 16. Accordingly, in terms of including the transmission antenna 11, the reception antenna 12, the RF front-end unit 13, the radar processing unit 14, the detection processing unit 15, and the tracking unit 16 of the radar device 1 illustrated in FIG. 1, the radar device 81 illustrated in FIG. 10 is the same as the radar device 1 illustrated in FIG. 1.

The radar processing unit 14 of the radar device 81 illustrated in FIG. 10 includes the FFT unit 51, the range cutout unit 52, and a CS processing unit 91. Accordingly, in terms of the radar processing unit 14 including the FFT unit 51 and the range cutout unit 52, the radar device 81 illustrated in FIG. 10 is the same as the radar processing unit 14 of the radar device 1 illustrated in FIG. 1.

However, the radar processing unit 14 of the radar device 81 illustrated in FIG. 10 differs from the radar processing unit 14 of the radar device 81 illustrated in FIG. 1 in that the CS processing unit 91 is provided instead of the high-resolution algorithm processing unit 53 in the radar processing unit 14 of the radar device 1 illustrated in FIG. 1.

The CS processing unit 91 in the radar device 81 illustrated in FIG. 10 performs processing of compressed sensing (CS) as a high-resolution algorithm. The CS processing unit 91 calculates a high-resolution angle spectrum of the high-resolution scanning range based on the steering matrix corresponding to the high-resolution scanning range θx from the range cutout unit 52 and the data of the high-resolution scanning range θx in the angle spectrum obtained through the angle FFT performed by the FFT unit 51.

Assume that a matrix constituted by component values cut out from the steering matrix (FFT) Msf illustrated in FIG. 6 according to the high-resolution scanning range θx is taken as a steering matrix A. Assume also that a matrix A′ is calculated through the following Formula (6).

$${A}^{′} = {( {A}^{H} A + ρ I )}^{- 1} \qquad ( 6 )$$

Note that A^{H} represents the Hermitian conjugate of the matrix A, I represents a unit matrix, and the symbol (−1) represents an inverse matrix.

The matrix A′ calculated through Formula (6) is used in CS. The steering matrix A is a matrix obtained by cutting out a range of component values corresponding to the high-resolution scanning range θx from the steering matrix (FFT) Msf described in the first embodiment of the radar device. As such, the CS processing unit 91 can use a method that calculates the matrix A′ according to the high-resolution scanning range θx as one method for obtaining the matrix A′. In other words, the CS processing unit 91 cuts out the steering matrix A from the steering matrix (FFT) Msf, which is prepared in advance, in accordance with the high-resolution scanning range θx determined by the range cutout unit 52. The CS processing unit 91 calculates the matrix A′ in Formula (6) above using the cut-out steering matrix A. However, when calculating the matrix A′ according to the high-resolution scanning range θx in this manner, the arithmetic processing takes time, and thus the CS processing unit 91 obtains the matrix A′ corresponding to the high-resolution scanning range θx from among a plurality of candidates for the matrix A′, generated in advance and stored in a storage unit (not shown). For example, a plurality of matrices corresponding to respective ones of high-resolution scanning ranges that can be set are generated in advance as matrices A₁′ to Aₓ′, and are stored in the radar processing unit 14 or the like. Note that several angle ranges which can be set may also be determined in advance as candidates for the high-resolution scanning range θx.

The CS processing unit 91 selects the matrix A′ corresponding to the high-resolution scanning range θx from the range cutout unit 52 from the matrices A₁′ to Aₓ′ generated in advance. The CS processing unit 91 then calculates the high-resolution angle spectrum for the high-resolution scanning range based on the selected matrix A′ and the data of the high-resolution scanning range θx in the angle spectrum obtained through the angle FFT performed by the FFT unit 51.

### <Flow of Processing by Radar Processing Unit 14 of Radar Device 81>

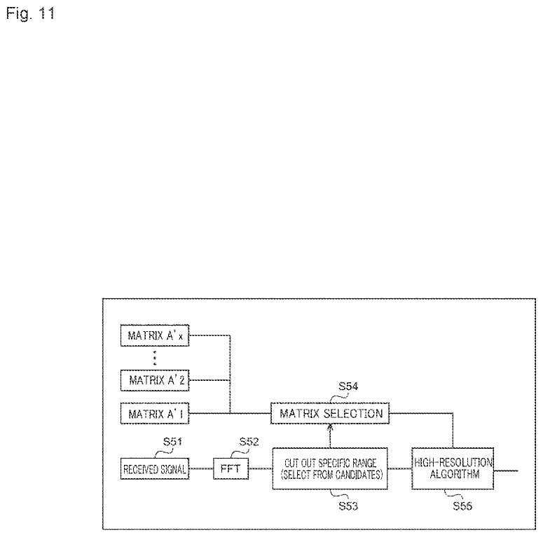

FIG. 11 is a diagram illustrating the flow of processing performed by the radar processing unit 14 of the radar device 81.

In FIG. 11, step S51 and step S52 are the same processing as step S11 and step S12 in FIG. 5, and will therefore not be described.

Like in step S13 in FIG. 5, in step S53, the range cutout unit 52 cuts out the angle spectrum data of a specific angle range to be used as the high-resolution scanning range θx from the entire angle range of the angle spectrum data obtained in step S52. However, if a plurality of angle ranges θ1 to θX that can be set as the high-resolution scanning range θx have been determined in advance as candidates, the range cutout unit 52 selects an appropriate angle range as the high-resolution scanning range θx from among the candidate angle ranges θ1 to θX.

In step S54, the CS processing unit 91 selects, as the matrix A′, the matrix corresponding to the high-resolution scanning range θx set by the range cutout unit 52 in step S53, from among the matrices A₁′ to Aₓ′ generated and stored in advance.

In step S55, the CS processing unit 91 performs processing using the high-resolution algorithm, based on the data of the angle spectrum in the high-resolution scanning range θx cut out in step S53 and the matrix A′ selected in step S54. A high-resolution angle spectrum in the high-resolution scanning range θx is calculated as a result.

According to the radar device 81 of the second embodiment described above, a range in which an object is present and a range in which no object is present can be identified quickly through the processing of an FFT (estimating the arrival direction using the low-resolution beamformer method), which involves a low arithmetic processing load. Through this, at least only a range where an object is present is scanned through the processing of the high-resolution algorithm, which involves a large arithmetic processing load, and the range where the object is present and the range where no object is present are identified at an even higher resolution. Accordingly, objects are recognized at a high resolution in important ranges, and an increase in the load and time required for arithmetic processing is suppressed. According to the radar device 1, the data obtained through the FFT can be used as-is to perform the processing of the high-resolution algorithm, which reduces the amount of calculations as well as the load and time required for arithmetic processing. According to the radar device 1, the range to which the high-resolution algorithm is applied is limited to a part of the scanning range of the radar device 1, and thus the dimensions of data to be input to the high-resolution algorithm are reduced, and the amount of calculations is greatly reduced. The method for obtaining the matrix A′ corresponding to the high-resolution scanning range θx from a plurality of candidates for the matrix A′ generated in advance, as in the second embodiment of the radar device, can also be applied when a method aside from CS is used as the high-resolution algorithm. In other words, the present technique also includes cases where, when generating a steering matrix corresponding to the high-resolution scanning range θx as in the first embodiment of the radar device, when generating the matrix A′ obtained by transforming a steering matrix corresponding to the high-resolution scanning range θx as in the second embodiment, or the like, the steering matrix or the matrix A′ used for the high-resolution algorithm is selected from a plurality of candidates generated in advance.

The present technique can also be configured as follows.

(1)

An information processing device including:
a Fourier transform unit that executes Fourier transform processing on a received signal received by an antenna;
a cutout unit that generates a second spectrum by cutting out a processing range from a first spectrum obtained by executing the Fourier transform processing;
a steering matrix generation unit that generates a steering matrix corresponding to the processing range; and
a processing unit that applies a high-resolution algorithm based on the second spectrum and the steering matrix.

(2)

The information processing device according to (1),
wherein the antenna is constituted by a plurality of antennas, and
the received signal is constituted by received signals from a plurality of channels, each channel received by a corresponding one of the plurality of antennas.

(3)

The information processing device according to (2),
wherein the Fourier transform unit calculates the first spectrum by calculating a frequency spectrum of the plurality of channels for each of the received signals of the plurality of channels by executing the Fourier transform processing on each of the received signals of the plurality of channels, and performing the Fourier transform processing on a component signal constituted by component values for a same frequency as the frequency spectrum of the plurality of channels.

(4)

The information processing device according to any one of (1) to (3),
wherein the first spectrum has a maximum intensity at a frequency corresponding to an angle of arrival of the received signal, and
the cutout unit takes, as the processing range, a range of frequencies including a frequency where the intensity of the first spectrum is maximum.

(5)

The information processing device according to (4),
wherein the cutout unit takes, as the processing range, a partial range among an entire frequency range of the first spectrum.

(6)

The information processing device according to any one of (1) to (5),
wherein the cutout unit takes, as the processing range, a partial range among an entire frequency range of the first spectrum, and changes the processing range to a plurality of different frequency ranges.

(7)

The information processing device according to any one of (2) to (6),
wherein when radio waves arriving from a same wave source are received as received signals by the plurality of antennas, the steering matrix generation unit generates the steering matrix based on a matrix obtained by executing Fourier transform processing on component values in a column direction of a first matrix, the first matrix expressing oscillation in amplitude arising among the received signals of the plurality of channels as the component values in the column direction.

(8)

The information processing device according to (7),
wherein the steering matrix generation unit takes, as the first matrix, a matrix in which, when angles of arrival of the radio waves are changed at predetermined intervals, the component values in the column direction are shifted in a row direction with respect to each of the angles of arrival.

(6)

The information processing device according to (7) or (8),
wherein the steering matrix generation unit generates the steering matrix by cutting out component values from a predetermined range of the first matrix.

(10)

The information processing device according to (9),
wherein the steering matrix generation unit cuts out a range of component values corresponding to the processing range in the first matrix.

(11)

The information processing device according to (1) to (6),
wherein the steering matrix generation unit selects the steering matrix corresponding to the processing range, or a matrix that is obtained by transforming the steering matrix and that is used in the high-resolution algorithm, from among a plurality of candidates created in advance for each of a plurality of different ones of the processing range.

(12)

The information processing device according to any one of (1) to (11),
wherein the Fourier transform unit generates an angle spectrum for an angle of arrival of a radio wave received by the antenna, the angle spectrum having a maximum intensity at the angle of arrival of the radio wave received by the antenna, as the first spectrum, based on a beamformer method.

(13)

The information processing device according to (12),
wherein the processing unit generates the angle spectrum in the processing range based on the high-resolution algorithm, the high-resolution algorithm estimating the angle of arrival of the radio wave received by the antenna at a resolution higher than a resolution of the beamformer method.

(14)

The information processing device according to (13),
wherein the processing unit uses, as the high-resolution algorithm, one of the following arrival direction estimation methods: Capon, CS, linear prediction, Pisarenko, MUSIC, or ESPRIT.

(15)
The information processing device according to any one of (1) to (14), wherein the cutout unit generates the second spectrum for each of first spectra obtained for each of distances from the antenna, each of the first spectra being the first spectrum.

(16)

The information processing device according to any one of (1) to (15),
wherein the cutout unit generates the second spectrum for the first spectrum, among first spectra obtained for each of distances from the antenna, for a distance at which an object is present, each of the first spectra being the first spectrum.

(17)

An information processing method by an information processing device including a Fourier transform unit, a cutout unit, a steering matrix generation unit, and a processing unit, the information processing method comprising:
executing Fourier transform processing on a received signal received by an antenna, by the Fourier transform unit;
generating a second spectrum by cutting out a processing range from a first spectrum obtained by executing the Fourier transform processing, by the cutout unit;
generating a steering matrix corresponding to the processing range, by the steering matrix generation unit; and
applying a high-resolution algorithm based on the second spectrum and the steering matrix, by the processing unit.

### REFERENCE SIGNS LIST

1, 81 Radar device
11 Transmission antenna
12 Reception antenna
13 RF front-end unit
14 Radar processing unit
15 Detection processing unit
16 Tracking unit
51 FFT unit
52 Range cutout unit
53 High-resolution algorithm processing unit
91 CS processing unit

1. An information processing device comprising:
a Fourier transform unit that executes Fourier transform processing on a received signal received by an antenna;
a cutout unit that generates a second spectrum by cutting out a processing range from a first spectrum obtained by executing the Fourier transform processing;
a steering matrix generation unit that generates a steering matrix corresponding to the processing range; and
a processing unit that applies a high-resolution algorithm based on the second spectrum and the steering matrix.

2. The information processing device according to claim 1,
wherein the antenna is constituted by a plurality of antennas, and
the received signal is constituted by received signals from a plurality of channels, each channel received by a corresponding one of the plurality of antennas.

3. The information processing device according to claim 2,
wherein the Fourier transform unit calculates the first spectrum by calculating a frequency spectrum of the plurality of channels for each of the received signals of the plurality of channels by executing the Fourier transform processing on each of the received signals of the plurality of channels, and performing the Fourier transform processing on a component signal constituted by component values for a same frequency as the frequency spectrum of the plurality of channels.

4. The information processing device according to claim 1,
wherein the first spectrum has a maximum intensity at a frequency corresponding to an angle of arrival of the received signal, and
the cutout unit takes, as the processing range, a range of frequencies including a frequency where the intensity of the first spectrum is maximum.

5. The information processing device according to claim 4,
wherein the cutout unit takes, as the processing range, a partial range among an entire frequency range of the first spectrum.

6. The information processing device according to claim 1,
wherein the cutout unit takes, as the processing range, a partial range among an entire frequency range of the first spectrum, and changes the processing range to a plurality of different frequency ranges.

7. The information processing device according to claim 2,
wherein when radio waves arriving from a same wave source are received as received signals by the plurality of antennas, the steering matrix generation unit generates the steering matrix based on a matrix obtained by executing Fourier transform processing on component values in a column direction of a first matrix, the first matrix expressing oscillation in amplitude arising among the received signals of the plurality of channels as the component values in the column direction.

8. The information processing device according to claim 7,
wherein the steering matrix generation unit takes, as the first matrix, a matrix in which, when angles of arrival of the radio waves are changed at predetermined intervals, the component values in the column direction are shifted in a row direction with respect to each of the angles of arrival.

9. The information processing device according to claim 7,
wherein the steering matrix generation unit generates the steering matrix by cutting out component values from a predetermined range of the first matrix.

10. The information processing device according to claim 9,
wherein the steering matrix generation unit cuts out a range of component values corresponding to the processing range in the first matrix.

11. The information processing device according to claim 1,
wherein the steering matrix generation unit selects the steering matrix corresponding to the processing range, or a matrix that is obtained by transforming the steering matrix and that is used in the high-resolution algorithm, from among a plurality of candidates created in advance for each of a plurality of different ones of the processing range.

12. The information processing device according to claim 1,
wherein the Fourier transform unit generates an angle spectrum for an angle of arrival of a radio wave received by the antenna, the angle spectrum having a maximum intensity at the angle of arrival of the radio wave received by the antenna, as the first spectrum, based on a beamformer method.

13. The information processing device according to claim 12,
wherein the processing unit generates the angle spectrum in the processing range based on the high-resolution algorithm, the high-resolution algorithm estimating the angle of arrival of the radio wave received by the antenna at a resolution higher than a resolution of the beamformer method.

14. The information processing device according to claim 13,
wherein the processing unit uses, as the high-resolution algorithm, one of the following arrival direction estimation methods: Capon, CS, linear prediction, Pisarenko, MUSIC, or ESPRIT.

15. The information processing device according to claim 1,
wherein the cutout unit generates the second spectrum for each of first spectra obtained for each of distances from the antenna, each of the first spectra being the first spectrum.

16. The information processing device according to claim 1,
wherein the cutout unit generates the second spectrum for the first spectrum, among first spectra obtained for each of distances from the antenna, for a distance at which an object is present, each of the first spectra being the first spectrum.

17. An information processing method by an information processing device including a Fourier transform unit, a cutout unit, a steering matrix generation unit, and a processing unit, the information processing method comprising:
executing Fourier transform processing on a received signal received by an antenna, by the Fourier transform unit;
generating a second spectrum by cutting out a processing range from a first spectrum obtained by executing the Fourier transform processing, by the cutout unit;
generating a steering matrix corresponding to the processing range, by the steering matrix generation unit; and
applying a high-resolution algorithm based on the second spectrum and the steering matrix, by the processing unit.
